(19) United States
(12) Patent Application Publication
(10) Pub. No.: US 2013/0086557 A1
(43) Pub. Date: Apr. 4, 2013

(54) SYSTEM FOR TESTING AND CERTIFYING A VIRTUAL APPLIANCE ON A CUSTOMER COMPUTER SYSTEM

(71) Applicants: Arul Murugan Alwar, Bangalore (IN); Rajadorai Easwaran, Bangalore (IN)

(72) Inventors: Arul Murugan Alwar, Bangalore (IN); Rajadorai Easwaran, Bangalore (IN)

(21) Appl. No.: 13/702,632

(22) PCT Filed: Jun. 21, 2010
(86) PCT No.: PCT/US2010/039387

§ 371 Date: Dec. 7, 2012

(51) Int. Cl. G06F 9/44

(52) U.S. Cl. CPC G06F 8/70
USPC 717/127

(57) ABSTRACT

A system including a customer computer system configured to receive a test from a vendor computer system and execute the test on the customer computer system to test and certify a virtual appliance on the customer computer system. A customer computer system provides test failure data to the vendor computer system in response to the test failing and the customer computer system provides baselining of the virtual appliance in response to the test passing.

### BACKGROUND

Typically, a software product is tested and certified by a vendor before the product is released to market. The product's quality assurance team updates regression test suites to cover changes introduced in each build released to the market. However, this process does not guarantee a defect-free product throughout the product's lifetime even if the customer applies all updates to the product and the customer's computer system.

A product undergoes several changes during its lifetime from the day it is deployed in the customer's computer environment. These changes include platform updates, product updates, system configuration changes, network configuration changes, and product configuration changes. As the runtime environment evolves, at some point a change introduced into the environment causes the product to break. Unfortunately, such breaks may not surface immediately. Instead, such breaks may surface only after an impacted feature is triggered, which can be many days or even weeks after the break.

When the defect surfaces, the customer does not know what caused the defect and hence raises a support call with the vendor. Due to the limited knowledge of the details and evolution of the runtime environment, the support team can spend a long time identifying the root cause of the problem, which causes customer dissatisfaction. Even if the customer uses a backup of the production environment, the backups may not work if the defect was triggered by external parameters such as the system or network configuration.

For these and other reasons there is a need for the present invention.

### BRIEF DESCRIPTION OF THE DRAWINGS

FIG. 1 is a diagram illustrating one embodiment of a system that includes a vendor computer system and customer computer systems.

FIG. 2 is a diagram illustrating one embodiment of a computer system that can be employed in the system of FIG. 1.

FIG. 3 is a diagram illustrating one embodiment of a vendor SaaS environment in a vendor computer system.

FIG. 4 is a diagram illustrating one embodiment of a managed customer computing environment in a customer computer system.

FIG. 5 is a diagram illustrating one embodiment of a first host machine and a second host machine.

FIG. 6 is a flow chart illustrating the operation of one embodiment of the system of FIG. 1.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

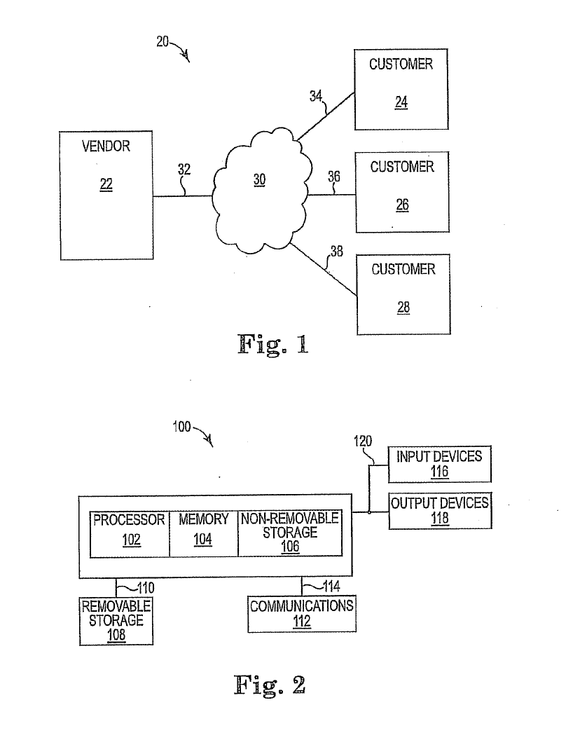

FIG. 1 is a diagram illustrating one embodiment of a system 20 that includes a vendor computer system 22 and customer computer systems 24, 26, and 28. Vendor computer system 22 is communicatively coupled to a network 30, such as the Internet or World Wide Web, via communications path 32. Customer computer systems 24, 26, and 28 are communicatively coupled to the network 30 via communication paths 34, 36, and 38, respectively. Vendor computer system 22 and customer computer systems 24, 26, and 28 communicate via the network 30. In other embodiments, system 20 includes any suitable number of customer computer systems, such as one or more customer computer systems.

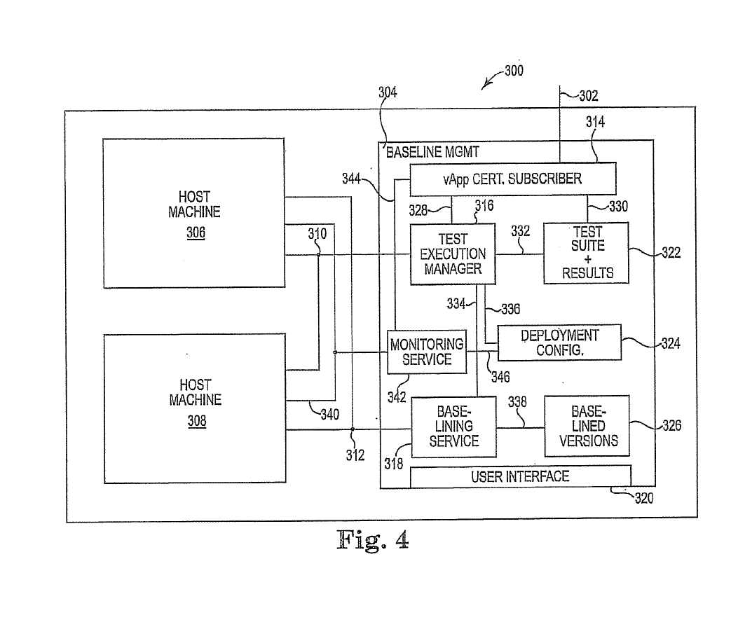

System 20 is built using software as a service (SaaS) and virtualization technologies. Virtual applications (vApps) operate in managed customer computing environments, such as managed customer computing environment 300 of FIG. 4. Each of the customer computer systems 24, 26, and 28 represents a managed customer computing environment, such as managed customer computing environment 300 of FIG. 4. Each vApp includes one or more virtual machines (VMs) connected together. System 20 includes the testing of vApps, including the VMs, in the managed customer computing environments. This reduces the time it takes for the customer and vendor to identify the root cause of a problem, which increases customer satisfaction.

In system 20, a customer can purchase one or more vApps via the vendor computer system 22 or through other sales channels and subscribe to a post-deployment vApp certification service for the purchased vApps via vendor computer system 22. The vApp certification service provides vApp updates and regression test suite updates for testing the vApps and certifying that the vApps operate on the subscribing customer's computer system, such as one of the customer computer systems 24, 26 and 28. Tests in the test suites include both test scripts and test data for testing vApps. Communication software is installed and/or activated in the subscribing customer's computer system for communicating with vendor computer system 22. Also, monitoring software is installed and/or activated in the subscribing customer's computer system for monitoring the customer's computer system and for sending runtime environment information about the customer's computer system to the vendor computer system 22. Runtime environment information includes operating system, service pack, update, patch, and product information, as well as hardware and network configurations, such as the number of processors and the internet protocol version (IPV). If a customer does not subscribe to the vApp certification service, the purchased vApps function normally in the customer's computing environment, but the vApp certification service is not available to the non-subscribing customer. In one embodiment, customers subscribe to the vApp certification service and install a subscription key to enable the vApp certification service. In one embodiment, customers subscribe to the vApp certification service for time periods, such as 90 days, yearly, or more than one year.

The monitoring software installed and/or activated on the subscribing customer's computer system, monitors changes in the runtime environment of the subscribing customer's computer system. The monitoring software detects changes in the platform including changes in the operating system, hardware, and products, where changes include patches and updates for each item. If a change is detected, the subscribing customer's computer system notifies the vendor computer system 22.

Customer computer systems 24, 26, and 28 incur at least two types of changes. A first type of change is an easily identifiable change, such as an operating system update or a service pack upgrade. A second type of change is a configuration change that is not easily detectable, such as a change to one or more environmental variables or a change to one or more registry key values. The monitoring software detects the easily identifiable changes of the first type, but the monitoring software does not detect the configuration changes of the second type.

If an easily identifiable change of the first type is first identified by the vendor proactively, without the aid of a customer computer system, the vendor builds a new runtime environment incorporating the change on the vendor computer system 22. The new runtime environment is the same as the currently certified computing environment of a subscribing customer plus the identified change, where the subscribing customer's computing environment is known via runtime computing environment information sent to the vendor computer system 22. The vendor runs old test suites and builds and runs new test suites to test vApps in the new runtime environment. If a failure occurs, the vendor generates vApp updates and test suite updates that are provided to subscribing customer computer systems. In this scenario, if the monitoring software on a subscribing customer's computer system detects the previously identified change and notifies the vendor computer system 22, the vApp updates and test suite updates are already available for downloading and for testing the vApps on the customer computer system.

If an easily identifiable change of the first type is first identified by the monitoring software in a subscribing customer's computer system, the vendor receives notification of the detected change and starts a support case in response to the notification. Support personnel build a runtime environment on the vendor computer system 22 that is the same as the runtime environment on the subscribing customer's computer system via runtime environment information sent to the vendor computer system 22. The support personnel then test vApps on the vendor computer system 22 using the newly built runtime environment. The vendor support personnel run old test suites and build and run new test suites to test vApps in the new runtime environment. Updates, such as vApp updates and test suite updates, are provided to the customer computer system for downloading and testing the vApps on the customer computer system.

A subscribing customer's computer system, such as one of the customer computer systems 24, 26, and 28, downloads vApp updates and test suite updates from the vendor computer system 22 to test the vApps in the runtime environment of the subscribing customer's computer system. The subscribing customer's computer system tests the vApps via the test suites to detect failures that occur on the subscribing customer's computer system. These failures may be due to the second type of change incurred by customer computer systems 24, 26, and 28 of configuration changes that are not easily detectable. The subscribing customer's computer system detects failures and notifies the vendor computer system 22 of the failures. In response, the vendor tests the vApps in a runtime environment on the vendor computer system 22 that is the same as the runtime environment on the subscribing customer's computer system and using the configurations and values from the subscribing customer's computer system. The vendor generates vApp updates and test suite updates that are downloaded by the subscribing customer's computer system for testing the vApps on the subscribing customer's computer system. This process repeats until the test suites pass on the subscribing customer's computer system. After passing, the subscribing customer's computer system baselines the vApps and stores a baseline copy of each vApp, where the baseline version can be used while waiting for updates.

FIG. 2 is a diagram illustrating one embodiment of a computer system 100 that can be employed in system 20. Computer system 100 includes physical computing components and may include virtual machines. In one embodiment, vendor computer system 22 is the same as or similar to computer system 100. In one embodiment, one or more of the managed customer computing environments represented by customer computer systems 24, 26, and 28 is the same as or similar to computer system 100.

Computer system 100 includes a processor architecture including at least one processing unit, i.e., processor 102, and memory 104. Memory 104 is volatile memory, non-volatile memory, or some combination of the two. In one embodiment, memory 104 is arranged in a memory hierarchy, such as a cache.

Computer system 100 includes additional storage including non-removable storage 106 and removable storage 108. This additional storage includes devices such as magnetic disks, optical disks, solid state memory, and/or flash storage devices. Processor 102 communicates with memory 104 and non-removable storage 106 and is communicatively coupled to removable storage 108 via storage path 110. The additional storage stores information such as computer readable instructions, data structures, program modules, and/or other data.

Computer system 100 is configured to run an operating system software program that can be stored on the storage media along with one or more software applications, which make up a system platform. Memory 104, non-removable storage 106, and removable storage 108 are all examples of computer storage media that can be used to store the desired information. Computer system 100 also includes one or more communication connections 112 communicatively coupled to processor 102 via communications path 114. The communication connections 112 allow computer system 100 to communicate with other computers/applications that can be used to store desired information and accessed by computer system 100.

User interface components of computer system 100 include one or more input devices 116, such as a keyboard, a pointing device (e.g., mouse), a voice input device, and/or a touch input device, and one or more output devices 118, such as a display and/or a printer. Input devices 116 and output devices 118 are communicatively coupled to processor 102 via input/output path 120.

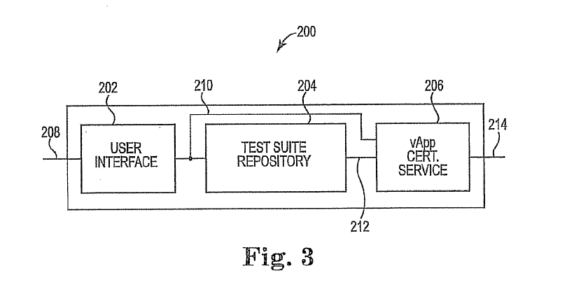

FIG. 3 is a diagram illustrating one embodiment of a vendor SaaS environment 200 in a vendor computer system, such as vendor computer system 22 (shown in FIG. 1). Vendor SaaS environment 200 includes a user interface 202, a test suite repository 204, and a vApp certification service 206.

At 208, vendor support personnel access vendor SaaS environment 200 via user interface 202. Vendor support personnel include engineers, technicians, and administrative personnel that work for the vendor. User interface 202 is communicatively coupled to test suite repository 204 and vApp certification service 206 via vendor communications path 210, which gives vendor support personnel access to test suite repository 204 and vApp certification service 206. In one embodiment, user interface 202 includes devices such as input devices 116 and output devices 118 (shown in FIG. 2).

Test suite repository 204 is a database including regression test suites for testing vApps sold by the vendor. The stored test suites include test suites developed for testing original vApp releases and new vApp releases and/or updates built in response to changes and failures that occur in the field. These changes and failures include easily identifiable changes of the first type and configuration changes of the second type. After an easily identifiable change of the first type is identified by the vendor or the monitoring software in a subscribing customer's computer system, the vendor support personnel run old test suites and build and run new test suites to test the vApp in the new runtime environment. These old and new test suites are stored in and accessed from test suite repository 204. Vendor support personnel store and access the test suites via user interface 202 and the customer's computer systems access the old and new test suites via vApp certification service 206. After testing the vApps on the customer's computer system, the vApp certification service 206 is notified of failures and vendor support personnel test the vApps in a new runtime environment including configurations from the subscribing customer's computer system. The vendor support personnel generate vApp updates and test suite updates that are stored in and accessed from test suite repository 204. In one embodiment, test suite repository 204 is stored in one or more storage media, such as memory 104, non-volatile storage 106, and/or removable storage 108 (shown in FIG. 2).

The vApp certification service 206 operates in vendor SaaS environment 200 to provide subscription services to customers of the vendor. The vApp certification service 206 is built over test suite repository 204 and communicatively coupled to test suite repository 204 via test suite communications path 212. The vApp certification service 206 retrieves test suites from test suite repository 204 via test suite communications path 212 and a test suite identification (ID). The test suite ID uniquely identifies a test suite and includes a build ID and other parameters from the customer's environment, such as operating system name and version, and service pack information. The build ID includes a vApp product number, a vApp version number, and the platform that the vApp was built to run on. The build ID changes every time there is a new full/partial vApp build released to the market, including upgrades, patches, and hot-fixes. Vendor support personnel upload test suites for each vApp build into test suite repository 204 via user interface 202. In one embodiment, vApp certification service 206 is executed via a processor, such as processor 102 (shown in FIG. 2).

The vApp certification service 206 communicates with customer computer systems, such as customer computer systems 24, 26, and 28 (shown in FIG. 1), to provide subscription services to the customer. Subscription services include subscribing customers to the service, receiving change and failure notifications from subscribing customer's computer systems, and providing subscription keys, test suites, and test suite updates to subscribing customer's computer systems. The vApp certification service 206 communicates with customer computer systems via network communications path 214. In one embodiment, vApp certification service 206 provides purchased vApps to the customer's computer systems via network communications path 214.

The vApp certification service 206 is a web service based on any suitable web service technology, including web service technologies that use proxies and data encryption. In one embodiment, vApp certification service 206 is built as a RESTful web service using the JAX-WS standards. In one embodiment, vApp certification service 206 is based on SOAP.

The vApp certification service 206 provides test suites to customers for testing vApps sold by the vendor on the customer's computer system. The test suites are downloaded by the customers, via network communications path 214, for testing purchased vApps on the customer's computer system. To download a test suite, the customer provides a test suite ID to the vApp certification service 206, which retrieves the identified test suite from test suite repository 204 and provides the retrieved test suite to the customer. The vApp certification service 206 provides original test suites and test suite updates for purchased vApps, including test suite updates built in response to vendor identified software and/or hardware changes.

The vApp certification service 206 receives notifications of easily identifiable changes of the first type from the monitoring software in a subscribing customer's computer system and notifications of testing failures from running the test suites on the subscribing customer's computer system. Also, the vApp certification service 206 receives customer computer system platform and/or configuration data from the subscribing customer's computer system. The vApp certification service 206 receives these reports and notifies vendor support personnel via user interface 202.

Vendor support personnel recreate the subscribing customer's computer system on the vendor computer system using the customer computer system platform and/or configuration data obtained from the subscribing customer's computer system. Vendor support personnel test the vApp via the recreated customer computer system on the vendor computer system. If the vApp fails the tests, the vendor support personnel update the vApp and build new test suites including test suite updates for testing the updated vApp. After passing the new test suites, vApp'updates are provided to customers whose computer systems and vApps contain the recently tested changes and new test suites are stored in test suite repository 204 and provided to subscribing customer's computer systems via network communications path 214. In one embodiment, vApp updates are provided via vApp certification service 206 and network communications path 214. The process continues until problems are resolved.

FIG. 4 is a diagram illustrating one embodiment of a managed customer computing environment 300 in a customer computer system. Each of the customer computer systems 24, 26, and 28 (shown in FIG. 1) represent a managed customer computing environment, such as managed customer computing environment 300. Managed customer computing environment 300 is communicatively coupled to vendor SaaS environment 200 via network communication path 302.

Managed customer computing environment 300 includes a baseline management system 304, a first host machine 306, and a second host machine 308. Baseline management system 304 is communicatively coupled to first host machine 306 and second host machine 308 via testing path 310, baselining path 312, and monitoring path 340. First and second host machines 306 and 308 are only examples of machines that can be in a managed customer computing environment, such as managed customer computing environment 300. In other embodiments, managed customer computing environment 300 includes baseline management system 304 and any suitable number of host machines, such as no host machines, one host machine, or more than two host machines.

Managed customer computing environment 300 includes monitoring software that monitors changes in managed customer computing environment 300 and provides change notifications to vendor SaaS environment 200. Managed customer computing environment 300 also provides test failure notifications to vendor SaaS environment 200. In response to these reports or notifications, the vendor computer system provides one or more test suites to the customer computer system. Also, the vendor computer system provides one or more test suites in response to changes in computer software and hardware without using reports or notifications from the customer computer system.

Baseline management system 304 manages at least some of the customer's computer system, including the customer's subscription to the vApp certification service, transmitting or uploading change notifications to the vendor computer system, downloading regression test suites from the vendor computer system, testing vApps on the customer's computer system, uploading test failure notifications to the vendor computer system, and baselining vApps on the customer's computer system. Baseline management system 304 communicates with vendor SaaS environment 200 via network communication path 302.

First and second host machines 306 and 308 are different physical computing machines in managed customer computing environment 300. The first host machine 306 is a first physical computing machine that executes one or more vApps received via the vendor. Each of the received vApps on first host machine 306 includes one or more VMs that are executed on first host machine 306. The second host machine 308 is a second physical computing machine that executes one or more vApps received via the vendor. Each of the received vApps on second host machine 308 includes one or more VMs that are executed on second host machine 308. In one embodiment, first host machine 306 executes one or more VMs of a vApp and second host machine 308 executes one or more other VMs of the same vApp.

Baseline management system 304 and first and second host machines 306 and 308 are logically different machines. In one embodiment, baseline management system 304 runs on a physical computing machine that is different than first host machine 306 and second host machine 308. In one embodiment, baseline management system 304 is a VM that runs on first host machine 306, where baseline management system 304 is a different VM than the VMs in the vApps. In one embodiment, baseline management system 304 is a VM that runs on second host machine 308, where baseline management system 304 is a different VM than the VMs in the vApps. In other embodiments, managed customer computing environment 300 includes one physical computing machine that includes baseline management system 304 and the vApps from the vendor, where baseline management system 304 is a different VM than the VMs in the vApps.

Baseline management system 304 includes five modules: the vApp certification subscriber 314, monitoring service 342, test execution manager 316, baselining service 318, and user interface 320. Baseline management system also includes three storage modules: test suite and result storage 322, deployment configuration database 324, and baselined version storage 326. In one embodiment, vApp certification subscriber 314, monitoring service 342, test execution manager 316, and baselining service 318 are software programs executed via a processor, such as processor 102 (shown in FIG. 2). In one embodiment, test suite and result storage 322, deployment configuration database 324, and/or baselined version storage 326 are in one or more storage media, such as memory 104, non-volatile storage 106, and/or removable storage 108 (shown in FIG. 2).

The vApp certification subscriber 314 operates as a subscriber to the vApp certification service and communicates with vApp certification service 206 via network communication path 302. The vApp certification subscriber 314 manages activation of the vApp subscription service in the customer's computer system, uploading information or data about managed customer computing environment 300 to the vendor computer system, uploading change notifications to the vendor computer system, downloading regression test suites from the vendor computer system, and uploading failed test results or notifications to the vendor computer system. The vApp certification subscriber 314 is communicatively coupled to vendor SaaS environment 200 via network communication path 302. In addition, the vApp certification subscriber 314 is communicatively coupled to monitoring service 342 via change notification path 344, to test execution manager 316 via test path 328, and to test suite and result storage 322 via storage path 330. In one embodiment, vApp certification subscriber 314 receives a subscription key from the vendor to activate the vApp subscription service in the customer's computer system. In one embodiment, vApp certification subscriber 314 downloads vApp subscription service software to activate the vApp subscription service in the customer's computer system.

New vApps and vApp updates are registered with baseline management system 304 via vApp certification subscriber 314. For each new vApp or vApp update, the vApp certification subscriber 314 obtains a build ID and/or a test suite ID and requests the test suite from the vendor SaaS environment 200. The vApp certification service 206 retrieves the test suite from test suite repository 204 and vApp certification subscriber 314 downloads the retrieved test suite from vApp certification service 206 via network communication path 302. The vApp certification subscriber 314 stores the downloaded test suite in test suite and result storage 322 via storage path 330. In one embodiment, the vApp certification subscriber 314 stores the downloaded test suite in test suite and result storage 322 via storage path 330 and notifies test execution manager 316 via test path 328 that a new test suite has been downloaded to test suite and result storage 322.

Monitoring service 342 manages monitoring of changes in managed customer computing environment 300. Monitoring service 342 is communicatively coupled to first host machine 306 and second host machine 308 via monitoring path 340. Monitoring service 342 communicates with one or more vApp monitoring agents to monitor vApps in first host machine 306 and second host machine 308. In one embodiment, the one or more monitoring agents are part of monitoring service 342. In one embodiment, the one or more monitoring agents are part of one or more host machines, such as first host machine 306 and second host machine 308, where monitoring service 342 communicates with the one or more monitoring agents remotely to monitor the vApps.

Monitoring service 342 populates and maintains deployment configuration database 324 via data path 346 and monitoring service 342 provides change notifications to vApp certification subscriber 314 via change notification path 344, which uploads the change notifications to vendor SaaS environment 200. In response to these reports or notifications, the vendor computer system provides one or more test suites to the customer computer system.

Test execution manager 316 manages scheduling and coordination of test suite execution on vApps in managed customer computing environment 300. Test execution manager 316 is communicatively coupled to first host machine 306 and second host machine 308 via testing path 310. Test execution manager 316 communicates with one or more vApp test agents to test vApps in first host machine 306 and second host machine 308. In one embodiment, the one or more test agents are part of test execution manager 316. In one embodiment, the one or more test agents are part of one or more host machines, such as first host machine 306 and second host machine 308, where test execution manager 316 activates the one or more test agents remotely to test the vApps.

To test a vApp, test execution manager 316 retrieves a test suite that corresponds to the vApp from test suite and result storage 322, where test execution manager 316 is communicatively coupled to test suite and result storage 322 via storage path 332. Test execution manager 316 transmits the retrieved test suite to a test agent that makes a copy of the vApp and inserts the test suite into the copy of the vApp to obtain test results. The test agent communicates the test results to test execution manager 316, which stores the test results in test suite and result storage 322 and communicates the test results to user interface 320. Also, test execution manager 316 notifies vApp certification subscriber 314 of test failures and vApp certification subscriber 314 uploads failed test results to vApp certification service 206. If the vApp passes, test execution manager 316 notifies baselining service 318, where test execution manager 316 is communicatively coupled to baselining service 318 via notification path 334.

Test execution manager 316 communicates with deployment configuration database 324 to find the vApps in the managed customer computing environment 300 and to schedule testing of the vApps. Deployment configuration database 324 includes the topology of managed customer computing environment 300, including host machines such as first host machine 306 and second host machine 308, the vApp location(s) and usage, and the VM location(s) and usage. Deployment configuration database 324 also includes the history of changes to managed customer computing environment 300. Test execution manager 316 is communicatively coupled to deployment configuration database 324 via configuration path 336. In one embodiment, deployment configuration database 324 includes time schedules for testing vApps.

After a vApp passes all test suites, test execution manager 316 notifies baselining service 318 and user interface 320. In response to the notification, baselining service 318 notifies a baselining agent that makes a copy of the vApp, where baselining service 318 is communicatively coupled to first host machine 306 and second host machine 308 via baselining path 312. Baselining service 318 receives the copy of the vApp from the baselining agent and baselines the copy of the vApp as the last known good version of the vApp. Baselining service 318 stores the baselined copy of the vApp in baselined version storage 326, where baselining service 318 is communicatively coupled to baselined version storage 326 via storage path 338. To revert to a previous copy of the vApp, one of the stored baselined versions of the vApp is retrieved from baselined version storage 326. In one embodiment, baselined version storage 326 stores historical baselined copies of a vApp. In one embodiment, baselined version storage 326 stores only the most recent baselined copy of the vApp. In one embodiment, baselining service 318 includes the baselining agent that remotely makes a copy of the vApp and passes the vApp copy to baselining service 318. In one embodiment, the baseline agent is part of the host machine, such as one of the first and second host machines 306 and 308, and baselining service 318 activates the baselining agent remotely to make a copy of the vApp and transmit the copy of the vApp to the baselining service 318.

User interface 320 provides customer support personnel access to managed customer computing environment 300 including access to vApp certification subscriber 314, test execution manager 316, and baselining service 318. Customer support personnel, including engineers, technicians, and administrative personnel, have access to set testing and baselining frequencies and deployment configurations. User interface 320 also generates reports, such as pass/fail reports and the configurations in which failures were detected. User interface 320 is communicatively coupled to vApp certification subscriber 314, test execution manager 316, and baselining service 318 via communication paths that are not shown for clarity. In one embodiment, user interface 320 includes devices such as input devices 116 and output devices 118 (shown in FIG. 2).

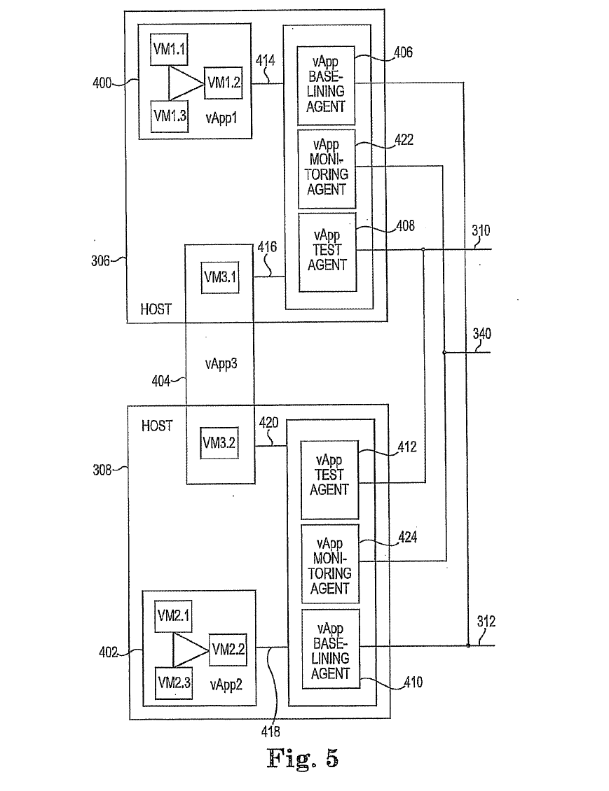

FIG. 5 is a diagram illustrating one embodiment of first host machine 306 and second host machine 308. First and second host machines 306 and 308 include three vApps: vApp1 at 400, vApp2 at 402, and vApp3 at 404. The vApp1 at 400 includes the three VMs of VM1.1, VM1.2, and VM1.3, which communicate with each other to provide vApp1 at 400. The Vapp2 at 402 includes the three VMs of VM2.1, VM2.2, and VM2.3, which communicate with each other to provide vApp2 at 402. The Vapp3 at 404 includes the two VMs of VM3.1 and VM3.2, which communicate with each other to provide vApp3 at 404.

First host machine 306 includes a first vApp monitoring agent 422, a first vApp baselining agent 406, and a first vApp test agent 408 that are communicatively coupled to vApp1 at 400 and VM3.1 that is part of vApp3 at 404 via vApp1 path 414 and first vApp3 path 416. Second host machine 308 includes a second vApp monitoring agent 424, a second vApp baselining agent 410, and a second vApp test agent 412 that are communicatively coupled to vApp2 at 402 and VM3.2 that is part of vApp3 at 404 via vApp2 path 418 and second vApp3 path 420. First vApp monitoring agent 422 and second vApp monitoring agent 424 are communicatively coupled to monitoring service 342 via monitoring path 340. First vApp test agent 408 and second vApp test agent 412 are communicatively coupled to test execution manager 316 via test path 310. First vApp baselining agent 406 and second vApp baselining agent 410 are communicatively coupled to baselining service 318 via baselining path 312.

Monitoring service 342 communicates with first and second vApp monitoring agents 422 and 424 to monitor vApps in first host machine 306 and second host machine 308. First and second vApp monitoring agents 422 and 424 provide updates to monitoring service 342 via monitoring path 340. Monitoring service 342 provides change notifications to vApp certification subscriber 314, which uploads the change notifications to vendor SaaS environment 200.

In operation, test execution manager 316 retrieves a test suite that corresponds to one of the three vApps of vApp1 at 400, vApp2 at 402, and vApp3 at 404, from test suite and result storage 322. Test execution manager 316 determines which of the first and second host machines 306 and 308 include the vApp that corresponds to the retrieved test suite via deployment configuration database 324. If the corresponding vApp is vApp1 at 400, first vApp test agent 408 in first host machine 306 receives the test suite, makes a copy of vApp1 at 400, and inserts the test suite into the copy of vApp1 at 400 to obtain test results. If the corresponding vApp is vApp2 at 402, second vApp test agent 412 in second host machine 308 receives the test suite, makes a copy of vApp2 at 402, and inserts the test suite into the copy of vApp2 at 402 to obtain test results. If the corresponding vApp is vApp3 at 404, first vApp test agent 408 in first host machine 306 and second vApp test agent 412 in second host machine 308 receive at least some of the test suite for testing VM3.1 and VM3.2, respectively. First vApp test agent 408 makes a copy of VM3.1 and inserts the test suite into the copy of VM3.1 to obtain test results and second vApp test agent 412 makes a copy of VM3.2 and inserts the test suite into the copy of VM3.2 to obtain test results.

The first and second vApp test agents 408 and 412 communicate test results to test execution manager 316, which stores the test results in test suite and result storage 322 and communicates the test results to user interface 320. Test execution manager 316 notifies vApp certification subscriber 314 of test failures and vApp certification subscriber 314 uploads failed test results to vApp certification service 206.

If the tested vApp passes, test execution manager 316 notifies baselining service 318, which notifies the vApp baselining agent(s) 406 and 410 in the host machine(s) 306 and 308 that include the tested vApp. If the tested vApp is vApp1 at 400, first vApp baselining agent 406 in first host machine 306 is activated to make a copy of vApp1 at 400. If the tested vApp is vApp2 at 402, second vApp baselining agent 410 in second host machine 308 is activated to make a copy of vApp2 at 402. If the tested vApp is vApp3 at 404, first vApp baselining agent 406 in first host machine 306 and second vApp baselining agent 410 in second host machine 308 are activated to make copies of VM3.1 and VM3.2, respectively.

Baselining service 318 receives the copy of the tested vApp from the baselining agent(s) 406 and 410 and baselines the copy of the tested vApp as the last known good version of the tested vApp. Baselining service 318 stores the baselined copy in baselined version storage 326.

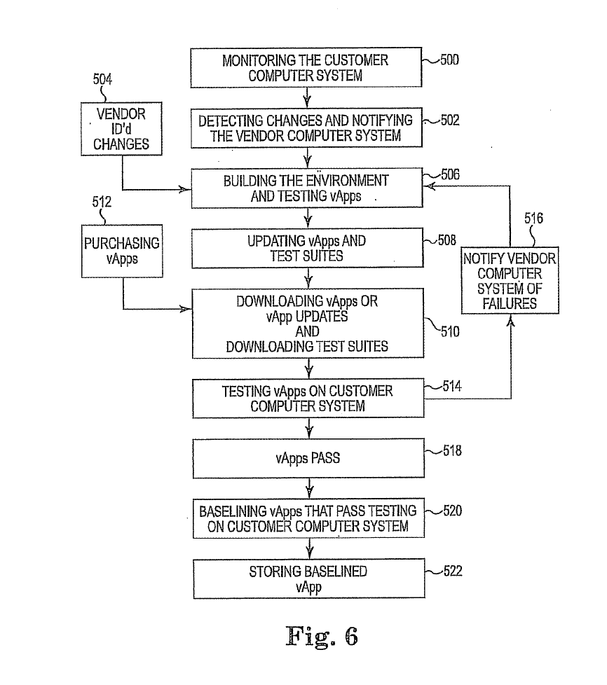

FIG. 6 is a flowchart illustrating the operation of one embodiment of system 20 for a subscriber to the vApp certification service. At 500, monitoring software installed in the subscribing customer's computing environment 300, monitors changes in the runtime environment of the subscribing customer's computer system. At 502, the monitoring software detects changes in the platform, including changes in the operating system, hardware, and/or products, where changes in the platform include patches and updates for each item. If a change is detected, the subscribing customer's computer system notifies vendor computer system 22. Also, at 504, the vendor identifies changes in computer software and hardware without receiving notifications from the customer computer system.

At 506, vendor support personnel recreate the subscribing customer's computer system on the vendor computer system 22 using the customer computer system platform and/or configuration data obtained from the subscribing customer's computer system. Vendor support personnel test one or more vApps via the recreated customer computer system on the vendor computer system 22. At 508, if the vApp fails, the vendor support personnel update the vApp and build new test suites, including test suite updates for testing the updated vApp. After passing the new test suites, the vApp updates are provided to customers and the new test suites are stored in test suite repository 204 and provided to subscribing customer's computer systems via network communications path 214.

At 510, vApp certification service 206 retrieves one or more test suites from test suite repository 204 and vApp certification subscriber 314 downloads updated vApps and the retrieved test suite(s) from vApp certification service 206. Also, if the customer purchases a new vApp at 512, the vApp certification subscriber 314 downloads the purchased vApp and a test suite from vApp certification service 206 at 510. The vApp certification subscriber 314 stores the downloaded test suite(s) in test suite and result storage 322.

At 514, test execution manager 316 retrieves a test suite that corresponds to a vApp from test suite and result storage 322. Test execution manager 316 determines which of the first and second host machines 306 and 308 include the vApp that corresponds to the retrieved test suite via deployment configuration database 324. If the corresponding vApp is vApp1 at 400, first vApp test agent 408 in first host machine 306 receives the test suite, makes a copy of vApp1 at 400, and inserts the test suite into the copy of vApp1 at 400 to obtain test results. If the corresponding vApp is vApp2 at 402, second vApp test agent 412 in second host machine 308 receives the test suite, makes a copy of vApp2 at 402, and inserts the test suite into the copy of vApp2 at 402 to obtain test results. If the corresponding vApp is vApp3 at 404, first vApp test agent 408 in first host machine 306 and second vApp test agent 412 in second host machine 308 receive at least some of the test suite for testing VM3.1 and VM3.2, respectively. First vApp test agent 408 makes a copy of VM3.1 and inserts the test suite into the copy of VM3.1 to obtain test results and second vApp test agent 412 makes a copy of VM3.2 and inserts the test suite into the copy of VM3.2 to obtain test results. The first and second vApp test agents 408 and 412 communicate test results to test execution manager 316, which stores the test results in test suite and result storage 322 and communicates the test results to user interface 320.

At 516, if the vApp fails testing, test execution manager 316 notifies vApp certification subscriber 314 of test failures and vApp certification subscriber 314 uploads failed test results to vApp certification service 206. The process continues at 506 with vendor support personnel recreating the subscribing customer's computer system on the vendor computer system 22 using the customer computer system platform and configuration data obtained from the subscribing customer's computer system. Next, the vendor support personnel test the vApp on the recreated customer computer system on the vendor computer system 22. The process continues at 508, 510, and 514.

At 518, if the vApp tested on the subscribing customer's computer system passes, test execution manager 316 notifies baselining service 318. At 520, baselining service 318 notifies the vApp baselining agent(s) 406 and 410 in the host machine(s) 306 and 308 that include the passing vApp. If the tested vApp is vApp1 at 400, first vApp baselining agent 406 in first host machine 306 is activated to make a copy of vApp1 at 400. If the tested vApp is vApp2 at 402, second vApp baselining agent 410 in second host machine 308 is activated to make a copy of vApp2 at 402. If the tested vApp is vApp3 at 404, first vApp baselining agent 406 in first host machine 306 and second vApp baselining agent 410 in second host machine 308 are activated to make copies of VM3.1 and VM3.2, respectively. Also, at 520, baselining service 318 receives the copy of the tested vApp from the baselining agent(s) 406 and 410 and baselines the copy of the tested vApp as the last known good version of the tested vApp. At 522, baselining service 318 stores the baselined copy in baselined version storage 326.

System 20 substantially guarantees that a subscribing customer's vApps are intact and running under the conditions certified by the vendor. System 20 instills confidence by detecting defects in vApps proactively and at an early stage, avoiding the chances of downtime. Also, if there is a problem with a vApp, the subscribing customer can revert to the last known certified, baselined version of the vApp. In addition, software vendors generate revenue by sharing test suites with the customers.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system, comprising:
a customer computer system configured to receive a test from a vendor computer system and execute the test on the customer computer system to test and certify a virtual appliance on the customer computer system, wherein the customer computer system provides test failure data to the vendor computer system in response to the test failing and the customer computer system provides baselining of the virtual appliance in response to the test passing.

2. The system of claim 1, wherein the customer computer system is configured to monitor itself and provide a report on changes in the customer computer system to the vendor computer system that provides the test to the customer computer system in response to the report.

3. The system of claim 2, comprising the vendor computer system configured to receive the report and test the virtual appliance on the vendor computer system after incorporating the changes in the customer computer system into the vendor computer system and, if the test fails, to provide updates for the virtual appliance.

4. The system of claim 1, wherein the test is created in response to changes in computer software and hardware without using reports from the customer computer system.

5. The system of claim 1, wherein the customer computer system is configured to make a copy of the virtual appliance on the customer computer system and to execute the test on the copy of the virtual appliance.

6. The system of claim 1, wherein the customer computer system includes one or more host computers and the virtual appliance includes multiple virtual machines such that each of the one or more host computers includes at least one virtual machine of the virtual appliance.

7. The system of claim 1, comprising the vendor computer system.

8. A computer readable storage medium storing instructions for controlling a customer computer system to perform a method comprising:
monitoring the customer computer system to detect changes in the customer computer system;
providing a report on the changes in the customer computer system to a vendor computer system, wherein a test is provided in response to the report;
receiving the test at the customer computer system from the vendor computer system; and
executing the test on the customer computer system to test a virtual appliance on the customer computer system.

9. The computer readable storage medium storing instructions for controlling the customer computer system to perform the method of claim 8 and comprising:
providing test failure data to the vendor computer system in response to the test failing; and
baselining the virtual appliance in response to the test passing.

10. The computer readable storage medium storing instructions for controlling the customer computer system to perform the method of claim 8 and comprising:
storing test results in the customer computer system;
storing baselined versions in the customer computer system; and
using one of the stored baselined versions of the virtual application.

11. A method of testing comprising:
building tests for testing a virtual appliance;
transferring at least one of the tests from a vendor computer system to a customer computer system for testing the virtual appliance on the customer computer system;
receiving test failure data from the customer computer system at the vendor computer system;
receiving customer computer system configuration data at the vendor computer system;
recreating the customer computer system on the vendor computer system; and
testing the virtual appliance via the recreated customer computer system on the vendor computer system.

12. The method of claim 11, comprising:
resolving problems with the virtual appliance via the recreated customer computer system on the vendor computer system; and
providing updates for the virtual appliance based on resolving the problems.

13. The method of claim 11, wherein building tests for testing the virtual appliance comprises:
building tests in response to software and hardware changes, without using the customer computer system configuration data.

14. The method of claim 11, wherein building tests for testing the virtual appliance comprises:
receiving reports on changes in the customer computer system at the vendor computer system;
recreating a changed customer computer system on the vendor computer system; and
building tests for testing the virtual appliance on the changed customer computer system.

15. The method of claim 14, comprising:
resolving problems with the virtual appliance via the recreated changed customer computer system on the vendor computer system; and
providing updates for the virtual appliance after resolving the problems.
